(19) United States
(12) Patent Application Publication
(10) Pub. No.: US 2026/0108860 A1
(43) Pub. Date: Apr. 23, 2026

(54) PRECISE SIZE AND SHAPE CONTROL OF COLLOIDS USING TEMPERATURE-ACTIVE BLOCK-COPOLYMER MICELLES

(71) Applicants: Jairo A. Diaz, Rochester, NY (US); Timothy Niper, Rochester, NY (US); Laura Galeano Tirado, Rochester, NY (US)

(72) Inventors: Jairo A. Diaz, Rochester, NY (US); Timothy Niper, Rochester, NY (US); Laura Galeano Tirado, Rochester, NY (US)

(73) Assignee: Rochester Institute of Technology, Rochester, NY (US)

(21) Appl. No.: 19/115,425

(22) PCT Filed: Sep. 29, 2023
(86) PCT No.: PCT/US2023/075468

§ 371 Date: Mar. 26, 2025

Related U.S. Application Data
(60) Provisional application No. 63/411,907, filed on Sep. 30, 2022.

(51) Int. Cl. B01J 13/00

(52) U.S. Cl. CPC B01J 13/0039; B01J 13/0021

(57) ABSTRACT

The present disclosure describes methods of producing colloids of precise sizes and shapes using temperature responsive block copolymers. A method of precise size control of colloids may include producing colloids in a solution of block copolymers, and POSS colloids. The temperature of the solution may be increased at a set rate to swell mesoscopic droplets to a precise size. A method of precise shape control of colloids may include polymerizing colloids in a solution of block copolymers, and POSS colloids and manipulating the temperature of the solution. In particular, the temperature of the solution may be increased at a set rate to swell and polymerize mesoscopic droplets and subsequently decreased at a set rate to collapse the colloids into a precise shape.

### CROSS-REFERENCE TO RELATED APPLICATIONS

This application claims priority to U.S. Provisional Application No. 63/411,907, filed on Sep. 30, 2022, entitled “PRECISE SIZE AND SHAPE CONTROL OF COLLOIDS USING TEMPERATURE-ACTIVE BLOCK-COPOLYMER MICELLES,” the contents of which are hereby incorporated by reference in its entirety.

### FIELD OF INVENTION

The invention relates to a process to control the size and shape of colloids with high precision using temperature responsive block copolymers.

### BACKGROUND

Currently, monodisperse colloidal particles used in academia or industry are manufactured either by emulsion polymerization or sol-gel chemistries. Such methods carry rapid changes in reaction and diffusion rates that occur while molecular precursors transform into colloids, opening little room to refine the control of colloidal properties in one step. In many cases, the final structural properties of the colloids like density, crosslinking and size are set from the start of the synthesis. The size of colloids becomes particularly limited to control as a continuum, which forces the production of only a discrete number of sizes. For instance, variants of the Stöber sol-gel process are typically preferred to make colloids with sizes ranging from tens of nanometers to up to a few microns.

Creating a colloid of a custom size is therefore challenging and currently requires post-synthesis steps that gradually approximate the desired target size. For instance, small and multiple additions of either more molecular precursors or organic solvents are needed to slowly increase the initial size of colloids by swelling the interior followed by additional steps of polymerization and solvent extraction. Toluene, dichloromethane (DCM) and tetrahydrofuran (TIF) are conventional organic solvents used for that purpose, yet their low environmental value and uncontrolled phase partition limits their modern use. More importantly, the resolution of size control is limited since small volumetric additions with difficulty translate into in small structural colloidal changes.

Thus, a need exists to produce monodisperse colloidal particles of a precise shape and size in an environmentally safe environment.

### SUMMARY

Various embodiments of the present invention provide methods of producing colloids of a precise size and shape utilizing temperature responsive block copolymers. Structural control of colloids may be achieved with temperature increases and decreases of polymeric micelle solutions.

Methods of producing colloids of a precise shape may combine the steps of providing a monomer precursor, block copolymers, and colloids, e.g., polyhedral oligomeric silsesquioxane (POSS) colloids, to form a mixture. The temperature is subsequently increased at a set rate to swell the droplets. The mixture may then be allowed to polymerize. The temperature of the mixture is then decreased at a set rate to collapse the droplets into the desired shape. Other steps may be included.

In various embodiments, the colloids provided may be polyhedral oligomeric silsesquioxane (POSS) colloids. The monomer precursor may be a polyhedral oligomeric silsesquioxane (POSS) colloid solution. The provided block copolymers may contain one or more hydrophobic chain and one or more hydrophilic chain. The block copolymers may be triblock copolymers. The block copolymers may be included at a concentration in the range of 0.1 to 10%.

In some embodiments, the rate of temperature increase may be in the range of 1 to 10° C./min. The rate of temperature decrease may be in the range of 1 to 10° C./min.

Methods of producing colloids of a precise size may combine the steps of providing pre-formed mesoscopic droplets suspended in an aqueous solution, providing block-polymers in an aqueous solution to form a solution. The solution may then be allowed to come to equilibrium. Subsequently, the temperature of the solution is increased at a set rate. The method may include allowing the solution to polymerize. The method may optionally include decreasing the temperature of the solution at a set rate. Other steps may be included.

In various embodiments, the provided mesoscopic droplets contain a silsesquioxane compound. In some embodiments, the provided mesoscopic droplets may be at a concentration of 0.1 to 10%. In some embodiments, the provided block-polymers may contain one or more hydrophobic chain and one or more hydrophilic chain. The block-polymers may be triblock copolymers.

In some embodiments, the rate of temperature increase may be in the range of 1 to 10° C./min. The increase in temperature may allow for thermal equilibrium. The rate of decrease in temperature in some embodiments may be in the range of 1 to 10° C./min.

While embodiments of the invention have been described, it will be apparent to those skilled in the art that various modifications, additions, substitutions, and the like can be made without departing from the spirit of the disclosure.

### BRIEF DESCRIPTION OF THE DRAWINGS

FIG. 1A depicts size vs. % (v/v) toluene added to 3-(trimethoxysilyl)propyl methacrylate (TPM) and FIG. 1B depicts a series of brightfield images of TPM with % (v/v) toluene added;

FIG. 2 depicts dynamic light scattering analyses of 1% L31 (aq);

FIG. 3A depicts heat capacity over temperature of varying percentages of L31,

FIG. 3B depicts fraction of total micelles of L31 in solution over temperature, and

FIG. 3C depicts brightfield of 10% L31 coacervate evolution over the thermal transition;

FIG. 4 depicts 2D reversible swelling of a TPM oil droplet with 10% L31 (aq) over temperature;

FIG. 5A depicts the conversion of L31 free coils into micelles along with their diffusion into TPM droplets and FIG. 5B depicts thermal expansion of TPM (φ=20, φL31=0.03) from 30° C. to 60° C. with insets showing the brightfield images of the droplets at each specific temperature;

FIG. 6A depicts: (left) effect of heat ramp on TPM (φ=10, φL31=0.05) radius from 30 to 75° C., and (right) effect of hold time, from 0 to 10 min on radius after various heat ramps, FIG. 6B depicts brightfield images of TPM ((=10, (L31=0.05) at a ramp of 1° C./min at various temperatures, and FIG. 6C depicts effect of temperature on zeta potential of TPM with various φL31;

FIG. 7A depicts brightfield images of swelling of low φ systems of TPM with φL31=0.03 over temperature at a heat ramp of 1° C./min and FIG. 7B depicts brightfield images of swelling of high φ systems of TPM with φL31=0.03 over temperature at a heat ramp of 1° C./min;

FIG. 8A depicts packing fraction vs. temperature of TPM (φ=20, φL31=0.03) from 27 to 55° C. and FIG. 8B depicts corresponding Voronoi diagrams for outlined region of interest; and

FIG. 9 depicts expanded droplets that are polymerized to produce solid colloidal particles of various shapes.

### DETAILED DESCRIPTION

Colloids are progressively expanding our technological capacity to create new materials. Embodiments of the present invention provide a route to gain structural control of colloids by remolding their shape from their interior utilizing temperature increases and decreases. Polymeric micelles may be used to swell the interstices of oligomeric colloidal droplets with the accuracy provided by the well-defined polymer micellization transition. Temperature and polymer concentration become the sole parameters governing not only the structure of colloids but also their interactions with the environment. The inventors found that temperature manipulation in particular allowed for precise control of the size and shape of droplets. By manipulating concentration of Pluronic and ramping the temperature up and down (as opposed to merely controlling the concentration of Pluronic), precise control of droplet size and shape may be achieved. Relevant colloidal phenomena like crystalline packing and polymerization can be continuously tuned to any practical value given the broad range of colloidal stability. The controlled absorption of polymeric micelles in bulk offers new opportunities to direct the transport of molecules for applications in physical and life sciences.

In various embodiments, size of colloids may be controlled by temperature manipulation of the solution. For example, an organic precursor (such as 3-(trimethoxysilyl)propyl methacrylate (TPM)) may be used in conjunction with a Pluronic (such as L31) to synthesize TPM colloids. After synthesis of the colloids, the temperature of the mixture is increased at a defined rate to induce swelling. By controlling the rate of temperature increase, precise control of swelling and droplet size may be achieved.

In various embodiments, the shape of the colloids may also be controlled by temperature manipulation of the solution. Colloids may be synthesized in an organic precursor (such as TPM) with the introduction of a Pluronic (L31). The temperature may be increased to induce micellar swelling. Subsequently, the temperature may be decreased to precisely induce a shape transformation of the colloids.

By incorporating the thermodynamic formation of polymeric micelles as part of the general Flory-Rehner equilibrium model, embodiments of the present invention allow for precise colloidal size control. In particular, a novel method of increasing and then decreasing temperature of a colloid-polymer solution allows for precise transformation of shape of colloids.

Embodiments of the present invention includes three novel continuum swelling regions:
1) a region where polymeric micelles can swell colloids without straining their elasticity limits, there, mostly spherical swollen colloids are fabricated upon polymerization;
2) a region where polymeric micelles strain the elasticity limit of droplets upon swelling, so buckled morphologies are readily created after polymerization; and
3) a region where swelling with polymeric micelles surpass the colloids elasticity limits, hindering polymerization of oligomeric networks inside colloids.

Embodiments of the present invention allow for expanded applications in soft matter by providing novel ways to create a new generation of colloids, refined control of packing, jamming, crystallization as well as a platform for simultaneous in-situ polymerization.

Large molecules, like polymeric surfactants, not only protect the surface of colloids but also act as swelling agents when their hydrophobic character is elevated. In particular, nonionic triblock copolymers (poloxamers or Pluronics®) composed of two polyethylene glycol (PEG) blocks, and one central polypropylene glycol (PPG) block show unique promise liquifying colloids and serving in colloidal self-assembly while reducing environmental impact. In particular, highly hydrophobic triblock copolymers can readily collapse with a small increase in temperature or concentration (i.e., entropic hydrophobic effect), especially when PPG blocks occupy more than 80% of the coil's molecular weight. In consequence, the entropy-driven coil collapse can rapidly trigger the appearance of polymeric micelles, which are considered to cause of the observed colloidal swelling. Additionally, the micellization ability of Pluronics increase when hydrophobic character of coils increases.

Some embodiments of the present invention utilize L61 (for example, TERGITOL™ by Dow), which contains 10% of PEG in their molecular structures. The relatively low PEG content of L61 makes it suitable to form micelles below room temperature with concentrations as low as 0.1%.

Various embodiments of the present invention utilize triblocks of larger PEG content such as F127 (for example, as produced by Sigma-Aldrich) (containing 70% PEG) or F108 (for example, as produced by Sigma-Aldrich) (containing 80% PEG). These larger PEG content triblocks may exist only as free polymer coils in solution at the same conditions.

It is known that a reduction in polymer molecular weight while keeping elevated hydrophobic character permits to split the two copolymer conformations around room temperature, where polymers exist mostly as free coils, or as spherical micelles, below and just above room temperature, respectively. This may be achieved through the use of L31 at room temperature.

Various embodiments of the present invention utilize L31, which has both a high hydrophobic character (90% PPG) and a low molecular weight (around 1.1 kDa). L61 and 31R1 may also be used as they are highly hydrophobic and have a low molecular weight. It was found that L31 micelles tend to remain as individual micelles in solution, and when subjected to a defined rate of temperature increase, allow for a resolution for swelling of colloids in bulk and precise size and shape control. Stable bulk swelling of colloids was found to be possible through the novel method of increasing the temperature of the mixture at a defined rate for precise size control, and subsequently decreasing the temperature at a second defined rate for precise shape control.

The heat capacity of L31 polymers is non-symmetric around the mean temperature value and is highly dependent on polymer concentration. The higher the polymer concentration, the narrower and deeper the energy profiles are as a function of temperature. In consequence, a large number of polymeric micelles can be created within a narrow range of rate of temperature change at concentrations around (3 to 10%). Various embodiments of the present utilize a concentration of L31 in the range of 0.1 to 10%.

The specific number of polymeric micelles present at any temperature and polymer concentration may be estimated as the conversion fraction of the polymer energy of micellization in solution, which is captured by the area under the curve of the heat capacity as a function temperature at a constant concentration.

The first micelles formed at the onset of the micellization transition reach hydrodynamic diameters sizes of and around 2.2 nm at low polymer concentration. It is known that polymeric micelles easily aggregate forming micron-sized coacervates when temperature or polymer concentration increase. However, it was found that the coacervation behavior of L31 changes drastically in the presence of colloids that swell by absorbing polymeric micelles in bulk.

Various embodiments of the present invention allow for the absorption of polymeric micelles utilizing hydrophobic PPG blocks. In embodiments that utilize L31, hydrophobic PPG blocks occupy more than 90% of the polymer chain and create highly hydrophobic polymeric micelles.

Various embodiments react PPG blocks with polyhedral oligomeric silsesquioxane (POSS) colloids prepared via sol-gel variants of the Stöber process. Embodiments also include utilizing a precursor that incorporates polymerizable functional groups. This allows for using colloids as monodisperse liquid droplets and that only polymerize when needed. Various embodiments of the present invention use 3-(trimethoxysilyl)propyl methacrylate (TPM) as precursor. TPM may be preferable due to its unique capacity to produce highly monodisperse emulsion droplets with high electrostatic stability.

Zeta potentials of typical emulsion droplets oscillate around negative 60 mV, which was found to eliminate the need of adding any additional surfactants to stabilize emulsions. The interior of TPM emulsion droplet differs from the classical colloidal droplets since the interior is not composed of small oil molecules freely diffusing but instead is composed by hydrophobic oligomeric chains created during the condensation steps of sol-gel process. Despite the more condensed interior, TPM droplets offer the capacity to isotropically and reversibly change size without major change in surface stability.

Various embodiments of the present invention bring polymers and emulsion droplets into contact, producing differing results depending on their relative concentration and temperature. For instance, in some embodiments droplets and polymers can freely diffuse with no interactions at temperatures below the onset of polymer micellization at a low polymer-to-droplet concentration. In some embodiments, by increasing the temperature, given that TPM droplets remain perfectly stable from room temperature (21° C.) to approximately 90° C., the polymer coils collapse into hydrophobic micelles. After their formation, polymeric micelles may rapidly permeate emulsion droplets acting as nanometric swelling packages whose abundance in solution can be finely tuned by the temperature control of the micellization transition.

It was found that as temperature increases, free polymer coils aggregate into polymeric micelles. If temperature increases more, the micelles can then aggregate into visible polymer droplets (coacervates) if they do not absorb into droplets. For shape control, with decreasing temperature, micelles “collapse” or revert back into their free coil form, resulting in a change in colloid shape.

The swelling of emulsion droplets can be conceptually framed in the fundamentals of polymer networks in equilibrium, where droplet swelling is largely controlled by a combination of the thermodynamics of mixing and polymer elasticity. Flory-Rehner provided an expression for the equilibrium swelling, wherein the volume fraction of the polymer in the swollen state, the Flory-Huggins interaction parameter, the molar volume of the solvent, and the number of crosslinking chains act as variables.

The thermal dependence of the solvent concentration estimated by the cumulative micellization transition. Various embodiments employ temperature ramps to guarantee equilibrium swelling. Heating ramps may range from 1 to 10° C./min. These rates may yield similar swelling behavior when keeping constant the overall polymer-to-droplet concentration. Some embodiments, utilizing the slowest ramp (1° C./min), exhibit a relatively rapid response to reach equilibrium and extended stability at the end of the micellization transition. Embodiments may use a relatively more rapid heating ramp, up to 10° C./min, to provide fast swelling but reduced droplet stability at high temperatures.

Continuous colloidal swelling may be obtained by adjusting up to two parameters: rate of temperature change and a set polymer-to-droplet concentration. At low polymer-to-droplet concentration, an abundance of droplets was found in the polymeric micelles' diffusional paths, which may ensure a highly uniform swelling in bulk as micelles may rapidly permeate every available colloid without straining their elasticity. This allows for uniform swelling at precise size control without the use of harsh organic solvents such as toluene.

The inventors found that predictions using the proposed variant of Flory-Rehner closely follow the swelling behavior as temperature increases. In an abundance of micelles at a relatively high polymer-to-droplet concentration, some micelles may continue to isotropically stretch colloids to extremely high expansion numbers while others remain in excess. It was found that micelles in excess rapidly aggregate in bulk forming micron-sized coacervates, as the estimated timescales for micelle formation are orders of magnitude faster than those estimated for droplet permeation. The swelling behavior at large ranges from the fine production of stable and mono-disperse swollen emulsion droplets to complete droplet breakup was found to yield a similar response to that produced by the addition of large volumes of a strong organic solvent such as toluene.

In various embodiments, expanded emulsion droplets may also be polymerized to produce solid colloidal particles of various size and shapes. Three distinct polymerization regimes governed by the level of droplet expansion were discovered and are used in various embodiments.

The first region in some embodiments allows for the creation of mesoporous spherical colloids in bulk. During swelling, oligomeric chains may preserve their condensation density inside droplets while physically unfolding when the internal volume fraction of micelles increases. Polymeric micelles may swell colloids without straining their elasticity limits. In some embodiments, this may result in nearly spherical swollen colloids are fabricated upon polymerization. This behavior is achieved in some embodiments at low polymer-to-droplet concentrations and in a broad range of temperatures. In some embodiments, short exposures, ranging from seconds to minutes, to UV light are needed to uniformly polymerize 2D arrays of droplets despite the level of packing.

The second polymerization region in some embodiments may produce non-spherical colloids with buckled morphologies. At intermediate to large droplet expansions, swelling is still reversible with no chemical breakages, yet oligomeric networks are more likely to reorganize accommodating big quantities of micelles. This easy reversibility through temperature decreases at a set rate allows for precise shape control of droplets. Droplet elasticity may be strained, but polymerizable functional groups can still react to harden the colloids. Although droplets remain spherical during polymerization, buckling may be triggered in various embodiments once micelles diffuse out of colloids by cooling the system to room temperature, changing their shape in a controlled and precise manner.

The third polymerization region is found in some embodiments at extremely high polymer-to-droplet concentrations. Droplets may continue to swell reversibly to more than ten times their initial size (i.e., a thousand factor increase in colloidal volumetric expansion). Droplets grow uniformly as individual colloids despite their decrease in surface electrostatic protection. The osmotic pressure generated by a large number of polymeric micelles inside droplets can surpass the colloids elasticity limits, hindering polymerization of oligomeric networks inside colloids.

These regimes may be defined by the following equations:

$${\prod }_{total} = {\prod }_{mix} + {\prod }_{elastic} = 0$$

$$[ ϕ + ln ( 1 - ϕ ) + {χϕ}^{2} ] - \frac{{υ}_{m} {n}_{c}}{{N}_{A}} [ ( \frac{ϕ}{2 {ϕ}_{0}} ) - {( \frac{ϕ}{{ϕ}_{0}} )}^{1 / 3} ] = 0$$

$${f}_{pm} ( {ϕ}_{p} , T ) = \frac{1}{Δ {H}_{m}} {\int }_{{T}_{0}}^{T} {C}_{p} ( {ϕ}_{p} , T ) dT$$

A unique control over colloidal packing may be obtained in various embodiments by tuning polymer-to-droplet concentration and temperature. Minimizing the formation of micron-sized micelle coacervates gives the opportunity to open free volume for droplets to occupy as they swell at higher temperatures.

Various embodiments utilize low to intermediate polymer-to-droplet concentrations create mixtures. This may maximize droplet swelling while nearly suppressing micellar aggregation. In consequence, emulsions can continuously grow filling the mixture's reservoir as temperature increases. Emulsions of various embodiments may contain mono-disperse droplets that occupy approximately 30% of the volume. Various embodiments increase the temperature, which may result in droplet swelling and packing at about 2.5%/° C. until the end of the polymer-to-micelle transition. Similar to other compressed fluid colloids, high packing fractions are reached upon droplet deformations.

Various embodiments control temperature down to 0.1° C., which may represent a control of 0.25% over emulsion packing. Fast droplet swelling allows for equilibrium to be rapidly reached, and various regimes may be identified. For example, in various embodiments a dilute or liquid regime occurs below about 54%, a transition to a RCHP around about 64%, and a hexatic order increases to crystalline compressed emulsions (greater than 80%).

In various embodiments, it was found that low and intermediate polymer-to-droplet concentrations along with temperature increases at a set rate allow for droplets to form large crystals relatively quickly. In these conditions, the expansion is moderate, and droplets may exhibit high electrostatic stability allowing for their free diffusion and reducing surface energy during crystal growth.

In various embodiments, droplets are preloaded with a photo-initiator (e.g., less than 0.1% Darocur). Short pulses of UV light may then trigger the controlled formation of free radicals to preserve the crystalline order. In various embodiments, other radical initiators may be used. This allows for crystalline grain boundaries to rearrange over time. The mobility of the grain boundaries reach steady state after full polymerization of droplets is completed, for example, in less than two hours. After polymerization, the new crystalline array may be composed by solid colloidal particles that may exhibit mesoporosity and topographic features created during extraction of swelling polymers.

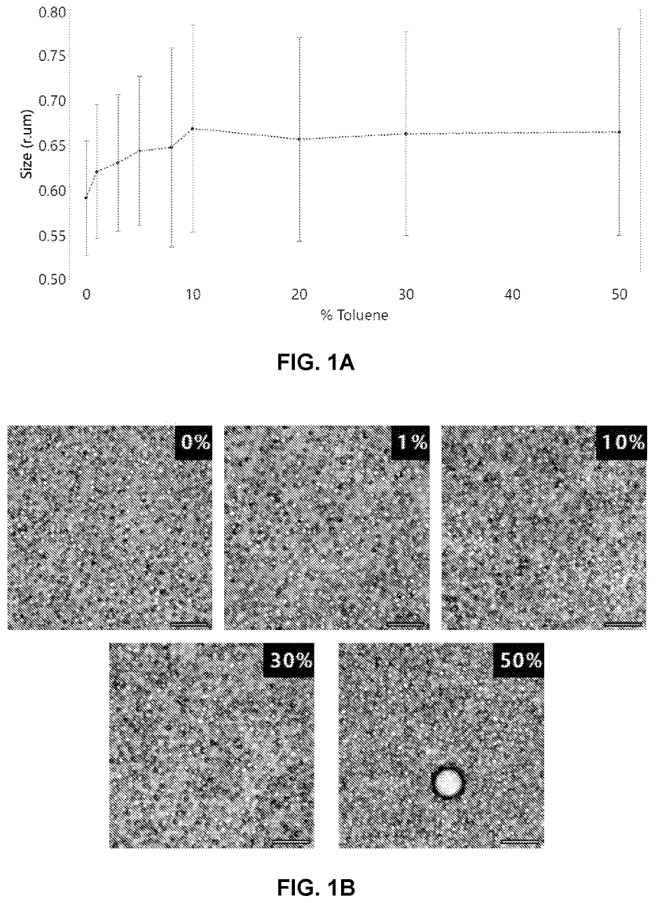

FIGS. 1A and 1B depict results of colloid size as a result of concentrations of toluene added as would be achieved in the prior art.

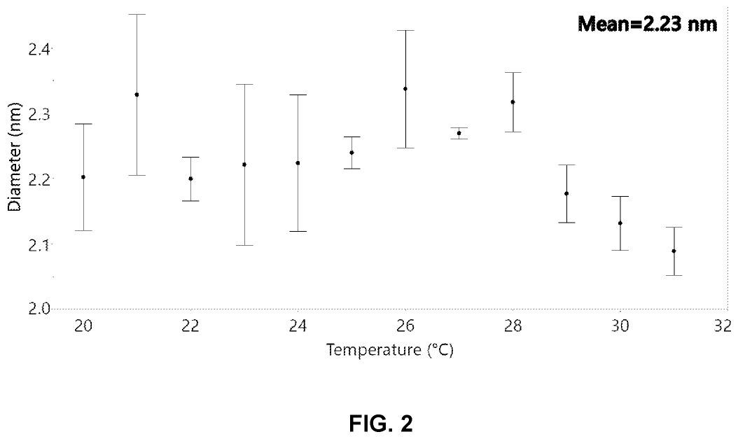

FIG. 2 depicts dynamic light scattering analyses of 1% L31 (aq). As implemented in various embodiments, diameter of colloids may be controlled by controlling the temperature of the solution.

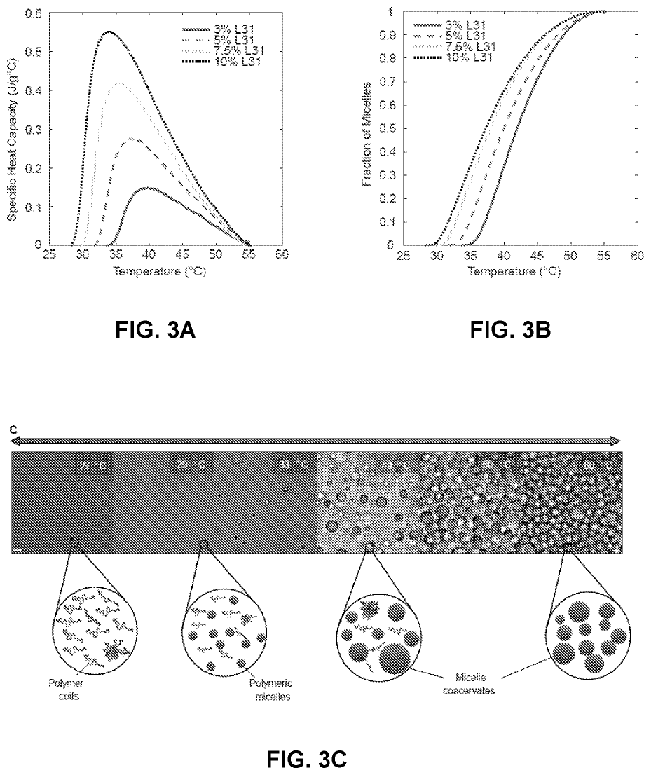

FIG. 3A depicts heat capacity over temperature at varying percentages of L31. FIG. 3B depicts fraction of total micelles of L31 in solution over temperature. As implemented in various embodiments, the specific heat capacity as well as the fraction of micelles may be controlled by controlling the temperature of the solution.

FIG. 3C depicts brightfield images of 10% L31 coacervate evolution over the thermal transition of the reaction. In various embodiments, increasing the temperature of the solution progresses the free polymer coils to polymeric micelles, and finally to micelle coacervates.

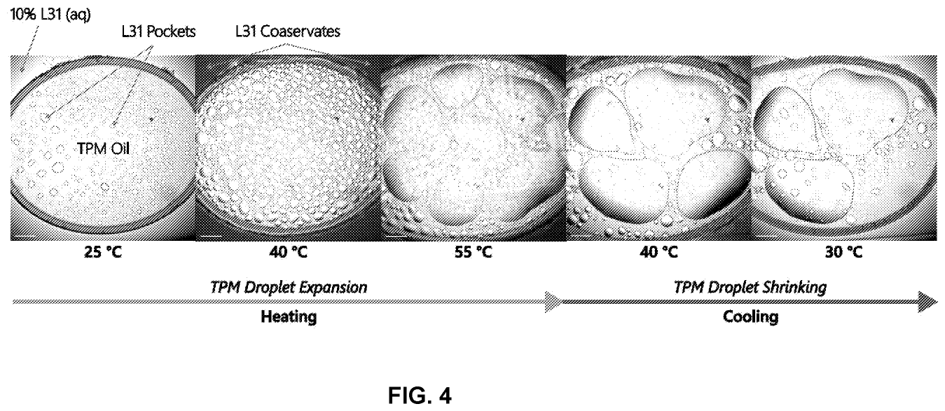

FIG. 4 depicts a reversible swelling of a TPM droplet with 10% L31 (aqueous). In various embodiments, temperature may be increased and then decreased to control not only the size of the droplets, but also the shape. As temperature is increased, swelling of the droplets occurs. After a desired size is achieved, the temperature of the solution may be decreased to control a shape transformation of the droplets.

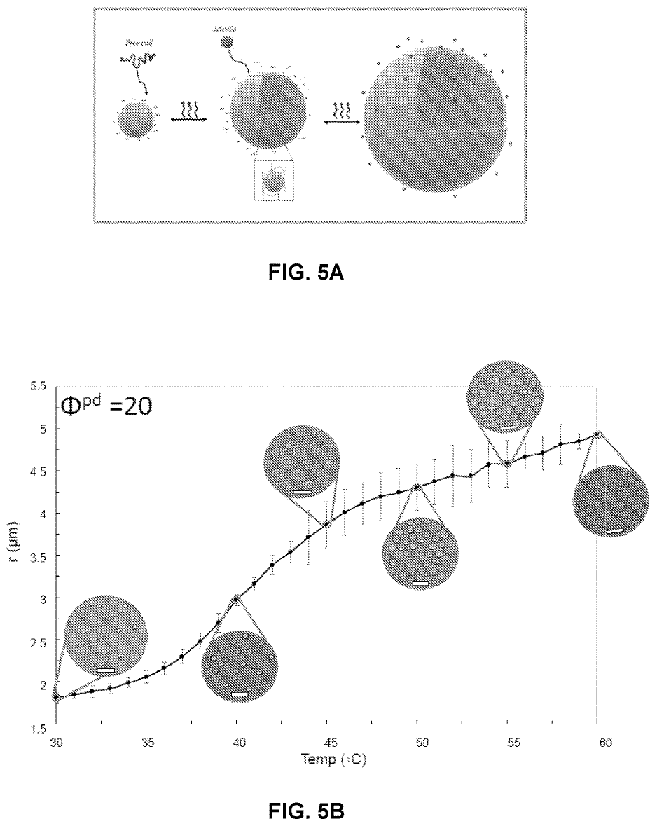

FIG. 5A depicts the conversion of L31 free coils into micelles with their diffusion into TPM droplets. The methods of various embodiments progress L31 free coils into micelles, which then diffuse into TPM droplets. This process controls the size and shape evolutions of colloids.

FIG. 5B depicts the thermal expansion of TPM as temperature increases. As temperature increases, the radius of the droplets increases as well. Insets show brightfield images of the droplets at specific temperatures. As can be seen in the brightfield images, droplet size increases as temperature increases.

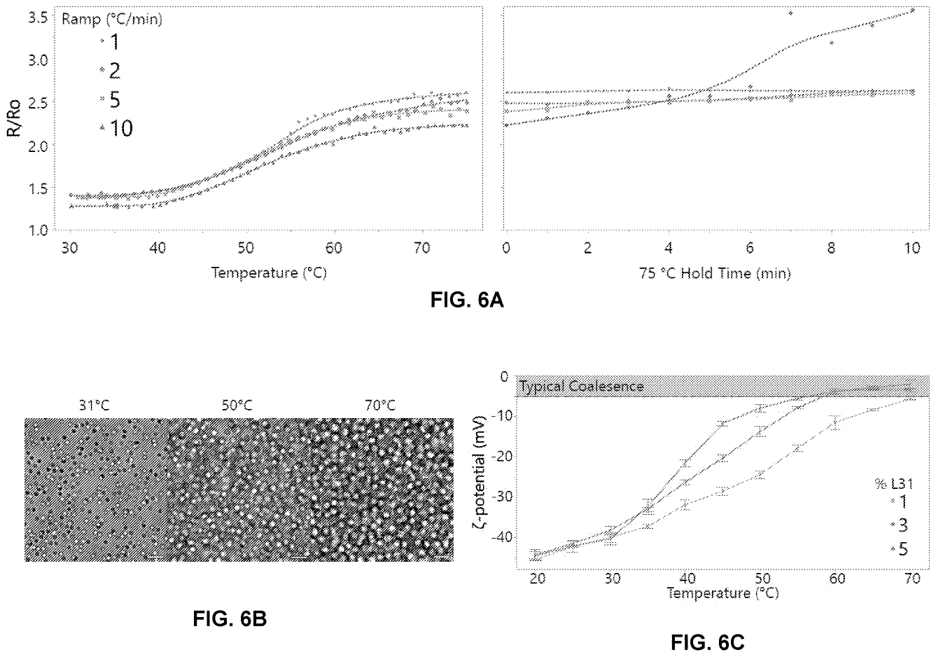

FIG. 6A (left) depicts the effect of increasing temperature on droplet radius. FIG. 6A (right) depicts the effect of hold time on radius after various temperature increases.

FIG. 6B (left) depicts brightfield images of TPM at a temperature increase of 1° C./min at various temperatures. As may be seen, droplet size increases with increased temperature. FIG. 6B (right) depicts the effect of temperature on zeta potential of TPM.

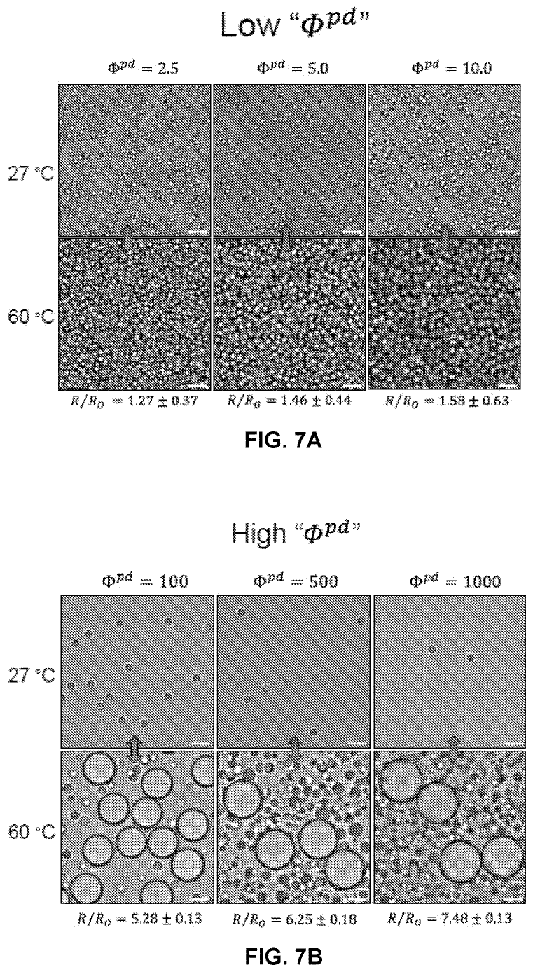

FIG. 7A depicts brightfield images of swelling of low φ systems of TPM with φL31=0.03 over temperatures at a temperature increase of 1° C./min. FIG. 7B depicts brightfield images of swelling of high φ systems of TPM with φL31=0.03 over temperatures at a temperature increase of 1° C./min. Smaller particles at high temperatures are polymer coacervates.

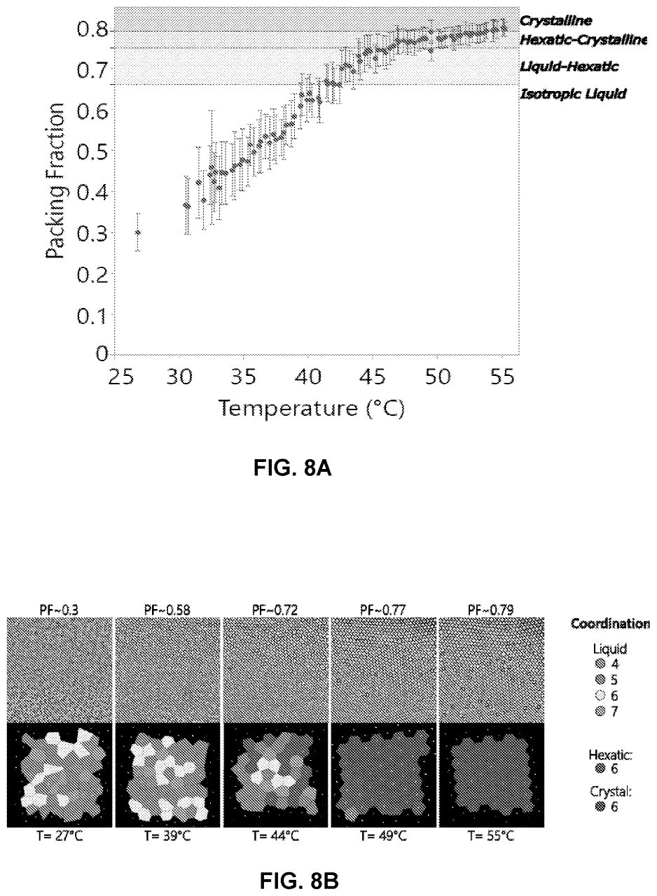

FIG. 8A depicts the effect of temperature of TPM on packing fraction. Four distinct phases exist: isotropic liquid, liquid-hexatic, hexatic-crystalline, and crystalline. FIG. 8B depicts corresponding Voronoi diagrams for outlined regions of interest. For liquids, the colors represent colloid coordination. For liquids, neighbor distance is not constant. For hexatic and crystalline coordinations, nearest neighbor distance is equal.

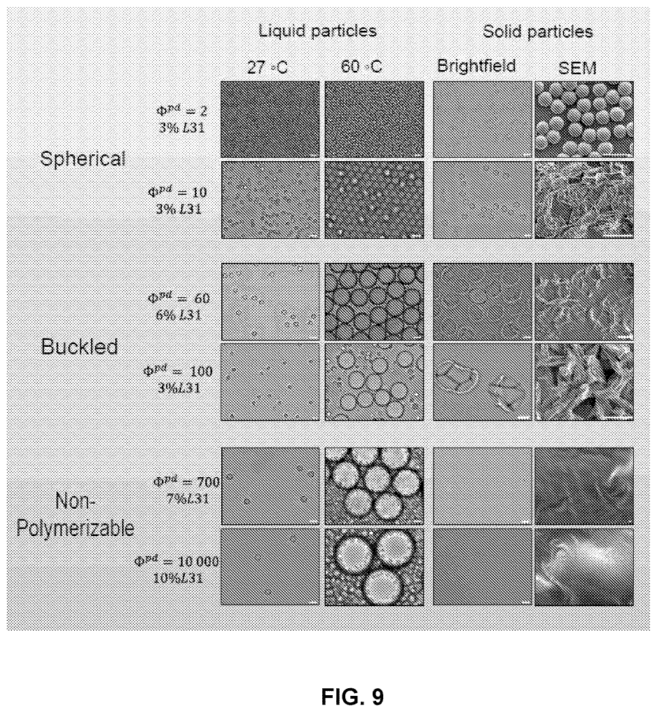

FIG. 9 depicts expanded droplets polymerized to produce solid colloidal particles of various shapes. Three polymerization regions are identified: spherical region, Buckled region, and Expandable-only region (no polymerization is achieved at these levels of expansion). Bright fields show the initial and final size of the liquid droplets at different φ^{pd} and the subsequent fixing of colloids after thermal polymerization. Scanning Electron Microscopy (SEM) reveals the dried aspect of polymerized particles.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

### EXAMPLES

### Example 1: Droplet Size Control

### Step 1 (Option 1): One-Step Emulsification

The one-step emulsification of TPM was performed as a one-pot reaction. A 1 inch stir bar was added to a 1 L glass beaker. 100 ml of Ultra-Pure Water (UPW) was added to the beaker and then capped with parafilm. The stir plate was set to agitate at about 200 RPM. 100 μl of 1 M HCl was added to the beaker and left to stir for about 1 min. 3 ml of TPM monomer was then added to the solution and stirred for about 10 more minutes. After acidified hydrolysis, 3 ml of 133.33 mM NaOH was then added to the solution and stirred for another about 60 min.

### Step 1 (Option 2): Full Hydrolysis Emulsification

A 0.25 inch stir bar was added to a 0.25 L glass beaker with 100 ml of UPW. Stir plate was set to agitate at about 400 RPM. 3 ml of TPM monomer was added to the beaker and then capped with parafilm. Solution was stirred until both liquids were visibly miscible, indicating full hydrolysis (about 60 min). Added linch stir bar to 1 L glass beaker. Transferred solution from 0.25 L beaker to 1 L beaker. Set stir plate to agitate at about 200 RPM. Added 75 l of NH3 to solution and then capped with parafilm. Stirred for additional about 60 min.

### Step 2: Pluronic® Addition

Prepared 10% v/v Pluronic® L31 solutions. In 1.5 ml Eppendorf® tubes, pipetted desired amount of Pluronic® solutions and emulsified TPM. Solutions were mixed on a thermal annealer (Eppendorf ThermoMixer C), set to 25° C. and 350 RPM, for about 5 min. Samples were inverted every minute during mixing to prevent sedimentation.

### Step 3: Thermal Stage Preparation

After Pluronic® addition, samples were drawn into 25.0 mm long capillaries with path length and wall of 0.1 mm and 2.0 mm width supplied by VitroCom. Filled capillaries were sealed and mounted onto glass slides using UV resin on the openings.

Sample slides were then placed on a conductive slide coated with indium tin oxide (ITO) with surface resistivity 15 to 25 Ω/sq, supplied by Sigma Aldrich, and positioned within a house-made thermal chamber. A 100Ω resistive temperature sensor (TH100PT) was placed at the center of the slide, just below the capillary tube, using copper tape. The thermal chamber was placed under a Nikon Eclipse Ti2 inverted microscope and then wired to a thermal annealer (THOR TC200). The thermal annealer was then programmed at its designated heat ramp and temperature points.

### Example 2: Micelle Characterization

To determine the critical micelle temperature (CMT) for the Pluronics®, a TA Instruments Differential Scanning Calorimeter (DSC) Q2000 was employed. A direct ramping method of 1° C./min was used over an interval of 0 to 70° C. with TZero Hermetic Lids and TZero Pans, each supplied by TA Instruments.

The initial size for Pluronic® micelles were determined by utilizing a Malvern Panalytical Zetasizer Nano ZS instrument. Hydrodynamic measurements were performed at a set interval of temperatures with three total replications, each containing 11 runs. Individual peaks, not the average of all peaks, were evaluated to determine the micelle size as the average of all peaks was typically inflated due to higher tier structures/aggregates.

### Example 3: Polymerization for Grain Boundary Analysis (Crystals and Packing)

After emulsification and Pluronic® addition for low and intermediate polymer-to-droplet concentrations, large crystals can be formed. In this scenario, droplets are preloaded with a 0.1% Darocur photo-initiator and placed in a capillary tube to track swelling and polymerization by optical microscopy. Temperature is increased to promote swelling and packing and subsequently held at 55° C. to initiate polymerization at maximum expansion. Short pulses (pulse every 5 seconds) of UV light are applied to control the formation of free radicals to preserve the crystalline order. After 60 min under UV exposure, temperature is decreased, and particles are removed from the capillary tube, by washing with 1% Pluronic® F-108 and Ultra-Pure water. Subsequently, samples were transferred to centrifuged tubes and centrifuged at 1,500 RPM for 3 min. The supernatant was removed and replaced with Ultra-Pure Water.

### Example 4: Droplet Shape Control

### Step 1: One-Step Emulsification

The one-step emulsification of TPM was performed as a one-pot reaction. A 1 inch stir bar was added to a 1 L glass beaker. 100 ml of UPW was added to the beaker and then capped with parafilm. The stir plate was set to agitate at about 200 RPM. 100 μl of 1 M HCl was added to the beaker and left to stir for about 1 min. 3 ml of TPM monomer was then added to the solution and stirred for about 10 more minutes. After acidified hydrolysis, 3 ml of 133.33 mM NaOH was then added to the solution and stirred for another about 60 min.

### Step 2: Pluronic® Addition

Prepared 10% v/v Pluronic® L31 solutions. In 1.5 ml Eppendorf® tubes, pipetted desired amount of Pluronic® solutions and emulsified TPM. Solutions were mixed on a thermal annealer (Eppendorf ThermoMixer C), set to 25° C. and 350 RPM, for about 5 min. Samples were inverted every minute during mixing to prevent sedimentation.

### Step 3: Polymerization for Shape

After emulsification and Pluronic® addition, droplets swollen at different φ were polymerized via radical polymerization with thermal initiators. 5 ml of droplets and Pluronic® mixture were hand mixed with 1 mg of Azobis(isobutyronitrile) (AIBN, ≥98%) in 20 ml glass vials. Samples were placed in an oven at 75° C. for 3 hours to trigger polymerization. Samples were hand-mixed every 30 min to reduce sedimentation. After polymerization, the temperature of the samples was reduced by removing vials from the oven and placing them at room temperature for 5 minutes, followed by the addition of 100 l of 1% Pluronic®F-108 to prevent coalescence. Subsequently, samples were transferred to centrifuged tubes and centrifuged (SORVALL ST8) at 1,500 RPM for 3 min. The supernatant was removed, and the pellet was washed with Ultra-Pure Water. Washed samples a total of 3 times to remove any excess AIBN and degraded droplets.

What is claimed is:

1. A method of controlling a shape transformation of colloids, the method comprising:
providing a monomer precursor;
providing triblock copolymers;
providing colloids to form a mixture;
increasing a temperature of the mixture at a first rate;
allowing polymerization of the mixture; and
decreasing the temperature of the mixture at a second rate.

2. The method as described in claim 1, wherein the first rate is between 1 and 10° C./min.

3. The method as described in claim 1, wherein the colloids are polyhedral oligomeric silsesquioxane (POSS) colloids.

4. The method as described in claim 1, wherein the monomer precursor is a polyhedral oligomeric silsesquioxane (POSS) colloid solution.

5. The method as described in claim 1, wherein the triblock copolymer contains one or more hydrophobic chain and one or more hydrophilic chain.

6. The method as described in claim 1, wherein a concentration of the triblock copolymers is in a range of from 0.1 to 10% volume/volume.

7. The method as described in claim 1, wherein the first rate is in a range of 1 to 10° C./min.

8. The method as described in claim 1, wherein the triblock copolymer is L31.

9. The method as described in claim 1, wherein the first rate is 1° C./min.

10. A method of swelling mesoscopic droplets, the method comprising:
providing pre-formed mesoscopic droplets suspended in an aqueous solution;
providing a block-polymer suspended in an aqueous solution;
allowing the solution to come to equilibrium; and
increasing a temperature of the solution at a set rate.

11. The method as described in claim 10, wherein the set rate is in a range of 1 to 10° C./min.

12. The method as described in claim 10, further comprising:
decreasing the temperature of the mixture at a set rate.

13. The method as described in claim 10, wherein the mesoscopic droplets contain a silsesquioxane compound.

14. The method as described in claim 10, wherein the block-polymer contains one or more hydrophobic chain and one or more hydrophilic chain.

15. The method as described in claim 8, wherein the increase in the temperature allows for thermal equilibrium.

16. The method as described in claim 10, wherein a concentration of block-polymers is in a range of 0.1 to 10% volume/volume.

17. The method as described in claim 10, further comprising:
allowing polymerization of the solution.

18. The method as described in claim 10, wherein the block-polymer is L31.

19. The method as described in claim 10, wherein the first rate is 1° C./min.

20. The method as described in claim 10, wherein the second rate is 1° C./min.
